(19) United States
(12) Patent Application Publication
(10) Pub. No.: US 2026/0262043 A1
(43) Pub. Date: Sep. 3, 2026

(54) PUSCH RESOURCE INDICATION MECHANISM

(71) Applicant: Lenovo (Beijing) Limited, Beijing (CN)

(72) Inventors: Ruixiang Ma, Beijing (CN); Yuantao Zhang, Beijing (CN); Zhi Yan, Beijing (CN)

(73) Assignee: Lenovo (Beijing) Limited, Beijing (CN)

(21) Appl. No.: 19/489,199

(22) PCT Filed: Jun. 20, 2023
(86) PCT No.: PCT/CN2023/101389

§ 371 Date: Dec. 1, 2025

(51) Int. Cl. H04W 72/21; H04L 5/00

(52) U.S. Cl. CPC H04W 72/21; H04L 5/0044

(57) ABSTRACT

Embodiments of the present disclosure relate to a UE, an NE, methods, apparatuses, and computer readable medium for PUSCH transmission. In some embodiments, the UE may receive, from an NE, information which is carried in a high layer message or a DCI, where the information indicates an extension resource of the PUSCH, and accordingly the UE may determine a resource for the PUSCH based on the information. Therefore, the UE may be aware of the resource for the PUSCH configured and/or indicated by the NE, and thus an uplink transmission may be performed on the resource and the transmission may be guaranteed.

### TECHNICAL FIELD

The present disclosure relates to wireless communications, and more specifically to a user equipment (UE), a network equipment (NE), apparatuses, methods, and computer readable medium for physical uplink shared channel (PUSCH) transmission.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

With development of communication technologies, several technologies have been proposed. For example, frequency domain spectrum shaping with spectrum extension (FDSS w/SE) has been proposed to reduce maximum power reduction (MPR). A basic method is to transmit the whole data in inband, and also extend it to the extension resource.

However, more details of the extension resource are still needed to be studied.

### SUMMARY

The present disclosure relates to a UE, an NE, methods, apparatuses, and computer readable medium for PUSCH transmission. Therefore, the UE may be aware of the resource for the PUSCH configured and/or indicated by the NE, and thus an uplink transmission may be guaranteed.

In a first aspect, there is provided a UE. The UE comprises at least one memory; and at least one processor coupled with the at least one memory and configured to cause the UE to: receive information from an NE, wherein the information is carried in a high layer message or downlink control information (DCI), and wherein the information indicates an extension resource of a PUSCH; and determine a resource for the PUSCH based on the information.

In a second aspect, there is provided an NE. The NE comprises at least one memory; and at least one processor coupled with the at least one memory and configured to cause the NE to: transmit information to a UE, wherein the information is carried in a high layer message or a DCI, and wherein the information indicates an extension resource of a PUSCH; and receive, from the UE, the PUSCH based on the information.

In a third aspect, there is provided a method performed by the UE. The method comprises: receiving information from an NE, wherein the information is carried in a high layer message or a DCI, and wherein the information indicates an extension resource of a PUSCH; and determining a resource for the PUSCH based on the information.

In a fourth aspect, there is provided a method performed by the NE. The method comprises: transmitting information to a UE, wherein the information is carried in a high layer message or a DCI, and wherein the information indicates an extension resource of a PUSCH; and receiving, from the UE, the PUSCH based on the information.

In a fifth aspect, there is provided a processor for wireless communication. The processor comprises at least one controller coupled with at least one memory and configured to cause the processor to: receive information from an NE, wherein the information is carried in a high layer message or a DCI, and wherein the information indicates an extension resource of a PUSCH; and determine a resource for the PUSCH based on the information.

In a sixth aspect, there is provided a processor for wireless communication. The processor comprises at least one controller coupled with at least one memory and configured to cause the processor to: transmit information to a UE, wherein the information is carried in a high layer message or a DCI, and wherein the information indicates an extension resource of a PUSCH; and receive, from the UE, the PUSCH based on the information.

In some implementations of the method and the UE described herein, the UE receives, from the NE, an indication indicating whether the PUSCH is extended.

In some implementations of the method and the UE described herein, the indication comprises at least one bit in the DCI.

In some implementations of the method and the UE described herein, bit fields carrying the at least one bit for different DCI formats are configured separately.

In some implementations of the method and the UE described herein, the indication is carried in a radio resource control (RRC) message based at least in part on the PUSCH being scheduled via a fallback DCI format or the PUSCH being a configured grant (CG) PUSCH. In some implementations of the method and the UE described herein, the indication is carried in a system information block (SIB) based at least in part on the PUSCH being a random access message of a random access procedure, the random access message comprises a message 3 (msg3) PUSCH.

In some implementations of the method and the UE described herein, the information comprises an extension factor, or an extension resource block (RB) number for indicating the extension resource.

In some implementations of the method and the UE described herein, the information comprises an index of the extension factor among a plurality of factors, or a resource size associated with the extension factor. In some implementations of the method and the UE described herein, the information comprises an index of the extension RB number of a plurality of RB numbers, or a resource size associated with the extension RB number.

In some implementations of the method and the UE described herein, the resource size comprises a size of an inband resource of the PUSCH, or a size of the resource for the PUSCH comprising the inband resource and the extension resource.

In some implementations of the method and the UE described herein, the UE receives, from the NE, a configuration comprising: the plurality of factors, the plurality of extension RB numbers, an association between at least one extension factor and at least one range of resource sizes, or an association between at least one extension RB number and at least one range of resource sizes.

In some implementations of the method and the UE described herein, in response to the extension resource being located outside a configured uplink subband of the UE and an inband resource being located within the configured uplink subband, the UE determines that the resource for the PUSCH comprises the inband resource and excludes the extension resource. In some implementations of the method and the UE described herein, in response to both the inband resource and the extension resource being located within the configured uplink subband, the UE determines that the resource for the PUSCH comprises the inband resource and the extension resource.

In some implementations of the method and the UE described herein, the UE determines uplink control information (UCI) to be multiplexed with the PUSCH; and determines whether to transmit the UCI on the PUSCH.

In some implementations of the method and the UE described herein, the UE determines that the resource for the PUSCH comprises an inband resource and excludes the extension resource; and transmits the UCI on the resource for the PUSCH.

In some implementations of the method and the UE described herein, the UE transmits the UCI on a physical uplink control channel (PUCCH) by dropping the PUSCH; or transmits one of the UCI or the PUSCH with a higher priority.

In some implementations of the method and the UE described herein, the UE determines that the resource for the PUSCH comprises an inband resource and the extension resource; and transmits the UCI or an extended UCI on the resource for the PUSCH.

In some implementations of the method and the UE described herein, the UE determines the extended UCI based at least in part on the UCI, one or more bits in the UCI, and an extension resource.

In some implementations of the method and the UE described herein, the UE determines a number of coded modulation symbols of the UCI or the extended UCI based at least in part on a size of the inband resource or a size of the resource for the PUSCH.

In some implementations of the method and the UE described herein, the UE maps coded modulation symbols of the UCI or the extended UCI from a lowest subcarrier index of the inband resource or from a lowest subcarrier index of the resource for the PUSCH.

In some implementations of the method and the NE described herein, the NE transmits, to the UE, an indication indicating whether the PUSCH is extended.

In some implementations of the method and the NE described herein, the indication comprises at least one bit in the DCI.

In some implementations of the method and the NE described herein, bit fields carrying the at least one bit for different DCI formats are configured separately.

In some implementations of the method and the NE described herein, the indication is carried in an RRC message based at least in part on the PUSCH being scheduled via a fallback DCI format or the PUSCH being a CG PUSCH. In some implementations of the method and the NE described herein, the indication is carried in a SIB based at least in part on the PUSCH being a random access message of a random access procedure, the random access message comprises a msg3 PUSCH.

In some implementations of the method and the NE described herein, the information comprises an extension factor, or an extension RB number for indicating the extension resource.

In some implementations of the method and the NE described herein, the information comprises an index of the extension factor among a plurality of factors, or a resource size associated with the extension factor. In some implementations of the method and the NE described herein, the information comprises an index of the extension RB number of a plurality of RB numbers, or a resource size associated with the extension RB number.

In some implementations of the method and the NE described herein, the resource size comprises a size of an inband resource of the PUSCH, or a size of the resource for the PUSCH comprising the inband resource and the extension resource.

In some implementations of the method and the NE described herein, the NE transmits, to the UE, a configuration comprising: the plurality of factors, the plurality of extension RB numbers, an association between at least one extension factor and at least one range of resource sizes, or an association between at least one extension RB number and at least one range of resource sizes.

In some implementations of the method and the NE described herein, the NE receives, from the UE, a UCI being multiplexed with the PUSCH on an inband resource or being transmitted on a PUCCH with the PUSCH being dropped.

In some implementations of the method and the NE described herein, the NE receives, from the UE, one of a UCI or the PUSCH with a higher priority.

In some implementations of the method and the NE described herein, the NE receives, from the UE, a UCI or an extended UCI being multiplexed with the PUSCH on the resource for the PUSCH comprising an inband resource and the extension resource.

In some implementations of the method and the NE described herein, the extended UCI is determined based at least in part on the UCI, one or more bits in the UCI, and an extension resource.

In some implementations of the method and the NE described herein, the UE determines a number of coded modulation symbols of the UCI or the extended UCI based at least in part on a size of the inband resource or a size of the resource for the PUSCH.

In some implementations of the method and the NE described herein, the coded modulation symbols of the UCI or the extended UCI are mapped from a lowest subcarrier index of the inband resource or from a lowest subcarrier index of the resource for the PUSCH.

### BRIEF DESCRIPTION OF THE DRAWINGS

FIG. 1 illustrates an example of a wireless communications system in which some embodiments of the present disclosure can be implemented;

FIG. 2 illustrates an example of a process flow in accordance with some example embodiments of the present disclosure;

FIG. 3 illustrates a schematic diagram of a source of a PUSCH in accordance with some example embodiments of the present disclosure;

FIG. 4 illustrates a schematic diagram of a relation between the PUSCH resource and configured uplink subband in accordance with some example embodiments of the present disclosure;

FIGS. 5A-5B illustrate schematic diagrams of frequency hopping offset in accordance with some example embodiments of the present disclosure;

FIG. 6 illustrates an example of a process flow in accordance with some example embodiments of the present disclosure;

FIGS. 7A-7B illustrate examples of uplink control information (UCI) mapping in accordance with some example embodiments of the present disclosure;

FIG. 8 illustrates an example of a device that is suitable for implementing embodiments of the present disclosure;

FIG. 9 illustrates an example of a processor that is suitable for implementing some embodiments of the present disclosure;

FIG. 10 illustrates a flowchart of a method that performed by a user equipment in accordance with aspects of the present disclosure; and

FIG. 11 illustrates a flowchart of a method that performed by a network equipment in accordance with aspects of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As mentioned above, FDSS w/SE is proposed to reduce MPR, for example, the following text box describes some related uplink (UL) coverage enhancement:

• Study and if necessary specify following power domain enhancements

| ∘ | Enhancements to realize increasing UE power high limit for CA and DC based on | |
|---|---|---|
| | Rel-17 RAN4 work on “Increasing UE power high limit for CA and DC”, in | |
| | compliance with relevant regulations | |
| | ▪ | Note 1: The study starts after RAN4 work on “Increasing UE power high |
| | | limit for CA and DC” is done depending on conclusions from RAN4. |
| | ▪ | Note 2: The objective will be revisited and further clarified in RAN plenary |
| | | after RAN4 work on “Increasing UE power high limit for CA and DC” is |
| | | done, and the discussion in WGs will not start before the objective is |
| | | revised with a clearer scope. |
| | ▪ | Note 3: Both RAN1 and RAN4 are expected to be involved; to decide the |
| | | order of either (RAN4, RAN1) or (RAN1, RAN4) later. |

| | |
|---|---|
| ∘ | Enhancements to reduce MPR/PAR, including frequency domain spectrum |
| | shaping with and without spectrum extension for DFT-S-OFDM and tone |
| | reservation (RAN4, RAN1) |

Some discussions have been made, e.g., focus on frequency domain resource allocation (FDRA), transport block size (TBS) determination, power determination. For example, some agreements about the indicated resource blocks (RBs) have been reached for FDSS w/SE, which are described in the following text box:

Working Assumption

| • | If FDSS-SE is supported in Rel-18: | |
|---|---|---|
| | • | transport block size is calculated using the number of PRBs in the inband. |
| | • | The number of PRBs used to determine the DFT size for transform precoding is the |
| | | number of PRBs in the inband. |

| | |
|---|---|
| • | FFS: how the number of PRBs/subcarriers in the inband is determined by the UE, i.e., |
| | details about FDRA indication |

Agreement

| • | If FDSS-SE is supported in Rel-18, RAN1 to down-select in RAN1 #114 only one of | |
|---|---|---|
| | the following options for spectrum extension configuration: | |
| | • | Option 1: Spectrum extension is [configured/indicated/determined] using an |
| | extension factor. One or more extension factors are supported | |
| | • | Option 2: Spectrum extension is [configured/indicated/determined] using an |

| | |
|---|---|
| | even number of PRBs. One or more candidate number of PRBs is supported |
| • | FFS: details. |
| • | Note: whether this has impact on DCI or not or has further specification impact or not |
| | is a separate discussion and is also subject to RAN4's conclusion to support FDSS-SE |
| | in Rel-18. |

Agreement

| • | If FDSS-SE is supported in Rel-18: | |
|---|---|---|
| | • | The number of resource blocks used to determine the PUSCH transmission power is |
| | | the number of PRBs in the total allocation |

| | |
|---|---|
| • | FFS: how the number of PRBs/sub-carriers in the inband and total allocation is |
| | determined by the UE, i.e., details about FDRA indication |

Working Assumption

| If FDSS-SE is supported in Rel-18: | |
|---|---|
| • | For PT-RS symbol mapping, the index m of PT-RS samples in OFDM symbol l |
| | prior to transform precoding is a function of the number of sub-carriers in the |
| | inband. |

FFS: how the number of PRBs/sub-carriers in the inband and total allocation is determined
by the UE, i.e., details about FDRA indication

In the present disclosure, the term “RB” and “PRB” may be used interchangeably in some cases. A PUSCH may be extended for the new UE in Rel-18, and a PUSCH could not be extended for both new UE and legacy UE in legacy release, so there may be at least two understandings on the resource indication for the new UE, in this event, how does the UE know which understanding is right should be decided.

Embodiments of the present disclosure provide a solution for PUSCH resource indication. In some embodiments, a UE may receive, from an NE, information which is carried in a high layer message or a DCI, where the information indicates an extension resource of the PUSCH, and accordingly the UE may determine a resource for the PUSCH based on the information. Therefore, the UE may be aware of the resource for the PUSCH configured and/or indicated by the NE, and thus an uplink transmission may be performed on the resource and the transmission may be guaranteed. Principles and implementations of the present disclosure will be described in detail below with reference to the figures.

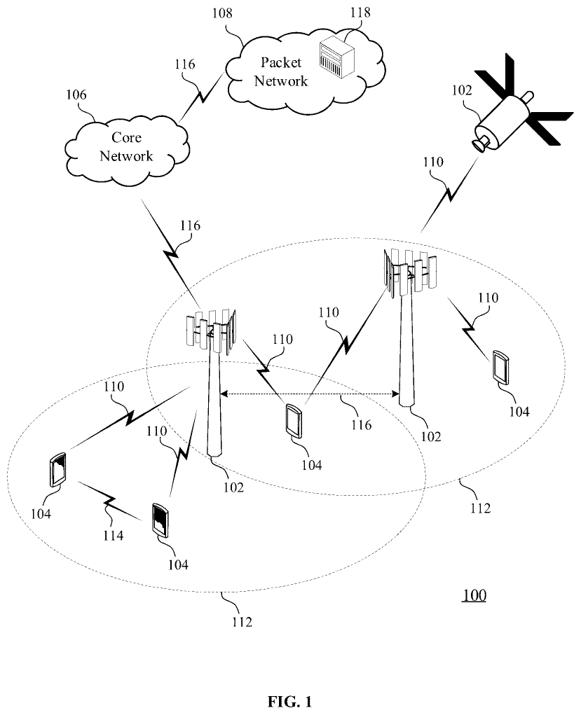

FIG. 1 illustrates an example of a wireless communications system 100 in which some embodiments of the present disclosure can be implemented. The wireless communications system 100 may include one or more network entities 102 (also referred to as network equipment (NE)), one or more UEs 104, a core network 106, and a packet data network 108. The wireless communications system 100 may support various radio access technologies. In some implementations, the wireless communications system 100 may be a 4G network, such as a long term evolution (LTE) network or an LTE-Advanced (LTE-A) network. In some other implementations, the wireless communications system 100 may be a 5G network, such as a new radio (NR) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink (SL). For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface).

In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1 c, F1 u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface).

The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

Additionally or alternatively, a time interval of a resource (e.g., a communication resource) may be organized according to symbols.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., p=2), which includes 60 kHz subcarrier spacing; and a fourth numerology (e.g., μ=3), which includes 120 kHz subcarrier spacing.

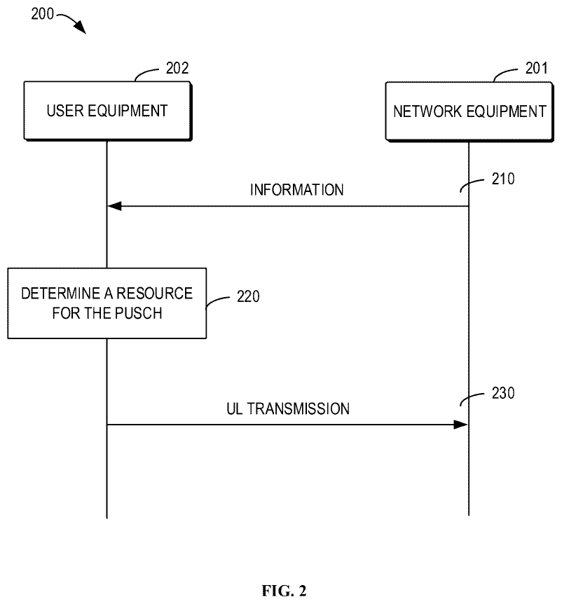

FIG. 2 illustrates an example of a process flow 200 in accordance with some example embodiments of the present disclosure. The process flow 200 may involve a network equipment 201 and a user equipment 202. The process flow 200 may be applied to the wireless communications system 100 with reference to FIG. 1, for example, the NE 201 may be a network entity 102 and the UE 202 may be a UE 104. It would be appreciated that the process flow 200 may be applied to other communication scenarios, which will not be described in detail.

The NE 201 transmits information to the UE 202, at 210, where the information indicates an extension resource of a PUSCH. In some example embodiments, the information may be carried in a high layer message, such as an RRC message. In some other example embodiments, the information may be carried in a DCI.

On the other side of communication, the UE 202 may receive the information from the NE 201, e.g., the UE 202 may receive the higher layer message or the DCI which carries the information. Accordingly, the UE 202 obtains the information indicating an extension resource of a PUSCH.

In some implementations, the information may indicate an extension factor which may be used for determining the extension resource of the PUSCH. In some other implementations, the information may indicate an extension RB number which may be used for determining the extension resource of the PUSCH. For example, the information may include one or more of: an index of the extension factor, an index of the extension RB number, or a resource size. The resource size may be associated with the extension factor or be associated with the extension RB number. The resource size may be a size of inband resource of the PUSCH, or may be a size of a PUSCH resource including the inband resource and the extension resource. In some examples, the resource size could be indicated by the information or indicated by other indication from the NE 201.

The UE 202 determines, at 220, a resource for the PUSCH based on the information. In the present disclosure, the resource for the PUSCH may also be called as a PUSCH resource, a resource for PUSCH transmission, a resource of the PUSCH, a resource of PUSCH transmission, or the like, the present disclosure does not limit this aspect. In some example embodiments, the UE 202 may also determine the inband resource. In addition, the UE 202 may further determine the resource for the PUSCH based on the inband resource and the extended resource.

In some example embodiments, a configuration from the NE 201 may be further used for determining the resource for the PUSCH. For example, the UE 202 may determine the inband resource and the extension resource based on the information and the configuration.

In addition or alternatively, the NE 201 may further transmit a configuration to the UE 202, where the configuration may be carried in another RRC message and be transmitted before 210. In some implementations, the configuration may include one or more of: multiple factors, multiple extension RB numbers, an association between at least one extension factor and at least one range of resource sizes, or an association between at least one extension RB number and at least one range of resource sizes.

In some examples, the information may include an index of the extension factor. The UE 202 may determine the extension factor based on the index from the multiple factors indicated by the configuration. For example, the multiple factors indicated by the configuration include {0.1, 0.25, 0.5, 0.8}, and the information includes 2bits and the information may be “01” which indicates that the extension factor is 0.25. For another example, the multiple factors indicated by the configuration include {0.1, 0.25}, and the information includes 1 bit and the information may be “0” which indicates that the extension factor is 0.1.

In addition, the UE 202 may determine the inband resource and the extension resource based on the information (indicating an extension factor) and the configuration. For example, the indicated extension factor may be represented as γ, and the resource size may be represented as N. If the resource size is a size of the inband resource of the PUSCH, then the UE 202 may determine that the inband resource has a size N, and the extension resource has a size [γ×N] or [γ×N]. If the resource size is a size of a total of the inband resource and the extension resource, then the UE 202 may determine that the inband resource has a size [N/(1+γ)] or [N/(1+γ)], and the extension resource has a size N−[N/(1+γ)] or N−[N/(1+γ)].

In some examples, the information may include an index of the extension RB number. The UE 202 may determine the extension RB number based on the index from the multiple RB numbers indicated by the configuration. For example, the indicated multiple factors by the configuration include {2, 4, 8, 16}, and the information includes 2bits and the information may be “01” which indicates that the extension RB number is 4. For another example, the indicated multiple factors by the configuration include {1, 2}, and the information includes 1 bit and the information may be “0” which indicates that extension RB number is 1.

In addition, the UE 202 may determine the inband resource and the extension resource based on the information (indicating an extension RB number) and the configuration. For example, the extension RB number may be represented as NO, and the resource size may be represented as N. If the resource size is a size of the inband resource of the PUSCH, then the UE 202 may determine that the inband resource has a size N, and the extension resource has a size N+N0×2. If the resource size is a size of a total of the inband resource and the extension resource, then the UE 202 may determine that the inband resource has a size N−N0×2, and the extension resource has a size NO. And the extension resource could be located as the start of the inband resource and the end of the inband resource.

In some examples, the information may include a resource size. The UE 202 may determine the extension factor or the extension RB number associated with the resource size, based on the association between at least one extension factor and at least one range of resource sizes or the association between at least one extension RB number and at least one range of resource sizes. For example, the configuration indicates that for RB number range {0, 50}, the associated extension factor is 0.2; and the configuration further indicates that for RB number range {51, 100}, the associated extension factor is 0.4. And then if the indicated resource size is 25, then it may be determined that the extension factor is 0.2; if the indicated resource size is 75, then it may be determined that the extension factor is 0.4.

For example, the configuration indicates that for RB number range {0, 50}, the associated extension RB number is 4RB; and the configuration further indicates that for RB number range {51, 100}, the associated extension RB number is 8RB. And then if the indicated resource size is 30, then it may be determined that the extension RB number is 4RB; if the indicated resource size is 80, then it may be determined that the extension RB number is 8RB.

The UE 202 may determine the inband resource and the extension resource based on the extension factor and the resource size, or based on the extension RB number and the resource size. For example, the extension RB number may be represented as NO, and the resource size may be represented as N. If the resource size is a size of the inband resource of the PUSCH, then the UE 202 may determine that the inband resource has a size N, and the extension resource has a size N0×2. If the resource size is a size of a total of the inband resource and the extension resource, then the UE 202 may determine that the inband resource has a size N−N0×2, and the extension resource has a size N0×2. And the extension resource could be located as the start of the inband resource and the end of the inband resource. For example, the indicated extension factor may be represented as γ, and the resource size may be represented as N. If the resource size is a size of the inband resource of the PUSCH, then the UE 202 may determine that the inband resource has a size N, and the extension resource has a size [γ×N] or [γ×N]. If the resource size is a size of a total of the inband resource and the extension resource, then the UE 202 may determine that the inband resource has a size [N/(1+γ)] or [N/(1+γ)], and the extension resource has a size N−[N/(1+γ)] or N−[N/(1+γ)].

The UE 202 determines the resource for the PUSCH at least based on the information. In some implementations, the resource for the PUSCH may include the inband resource and exclude the extension resource. In some other implementations, the resource for the PUSCH may include the inband resource and the extension resource.

In some example embodiments, the NE 201 may further transmit an indication to the UE 202, where the indication may indicate whether the PUSCH is extended. In some implementations, the indication may be carried in a same message that carries the information discussed at 210. In some other implementations, the indication may be carried in another message different from that carries the information. In some examples, the indication may be carried in RRC signalling, e.g., the RRC signalling may be used to indicate whether the PUSCH is extended. In some other examples, the indication may be carried in a DCI, e.g., the DCI may be used to indicate whether the PUSCH is extended; as such, a dynamic method may be considered so as to reduce the latency.

In some implementations, the indication may include at least one bit in a DCI. In some examples, at least one bit may be configured for a DCI format of the DCI. For example, one bit may be added in the DCI to indicate whether the PUSCH should be extended, where a bit field carrying the bit may be configured existed or not.

In some examples, the bit fields carrying the at least one bit for different DCI formats may be configured separately. For example, for DCI formats 0_1 and 0_2, the bit fields may be configured separately. For example, for DCI formats 0_1, it could be configured the bit field is existed, but for DCI formats 0_2, the bit could be configured not existed.

In some examples, if the PUSCH is scheduled by a fallback DCI format (such as DCI format 0_0), the indication may be carried in a higher layer message, such as RRC signalling. In some examples, if the PUSCH is a CG PUSCH, the indication may be carried in a higher layer message, such as RRC signalling. In some other examples, if the PUSCH is a msg3 PUSCH, the indication may be carried in a system information block 1 (SIB1).

In some implementations, if the indication indicates that the PUSCH should not be extended, then the UE 202 may determine that the resource for the PUSCH includes the inband resource and excludes the extension resource.

In some implementations, if the indication indicates that the PUSCH should be extended, then the UE 202 may determine that the resource for the PUSCH includes the inband resource and the extension resource, i.e., the resource for the PUSCH includes a total of the inband resource and the extension resource. In some other implementations, in case the indication indicates that the PUSCH should be extended, the UE 202 may determine the resource for the PUSCH further based on a configured uplink subband of the UE 202.

In some examples, if the extension resource (e.g., part of the extension resource) is located outside the confitured uplink sunband of the UE 202 and the inband resource (e.g., all of the inband resource) is located within the confitured uplink sunband of the UE 202, the UE 202 may determine that the resource for the PUSCH includes the inband resource and excludes the extension resource. In some other examples, if both the extension resource (e.g., all of the extension resource) and the inband resource (e.g., all of the inband resource) are located within the confitured uplink sunband of the UE 202, the UE 202 may determine that the resource for the PUSCH includes the inband resource and the extension resource.

In addition or alternatively, the UE 202 may perform an uplink transmission, at 230. In some examples, the UE 202 may transmit the PUSCH to the NE 201 on the resource for the PUSCH.

In some implementations, a frequency hopping may be configured or indicated for the PUSCH. The UE 202 may transmit the PUSCH for at least two hops. In some examples, a hopping offset between two adjacent hops may be understood as: a frequency domain interval between two starting PRBs of inband resources of two hops, or a frequency domain interval between two starting PRBs of all resources (including the inband resource and the extension resource) of two hops.

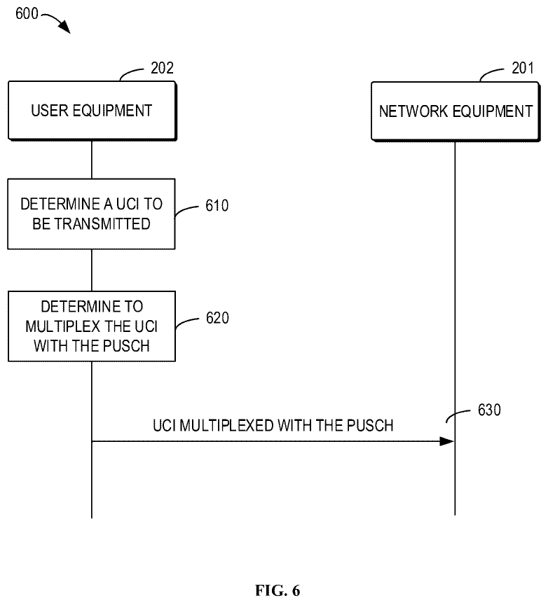

In some example embodiments, the UE 202 may determine to transmit a UCI, e.g., the UCI is to be multiplexed with the PUSCH. In addition, the UE 202 may determine whether to transmit the UCI on the PUSCH or not. In some examples, the UCI may be multiplexed in the PUSCH transmission. In some other examples, the UCI may be transmitted through a PUCCH. In some other examples, the UCI may be dropped. Some detailed description of the UCI transmission may refer to embodiments with reference to FIG. 6 below.

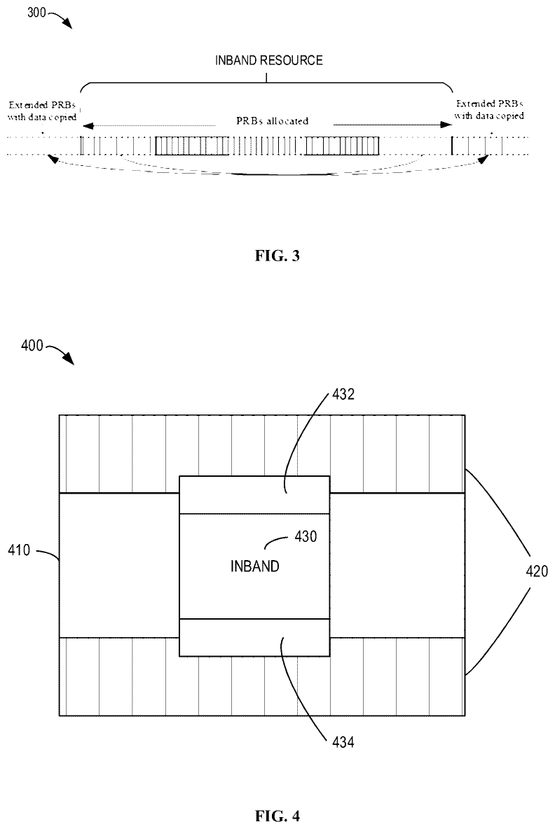

FIG. 3 illustrates a schematic diagram of a source 300 of a PUSCH in accordance with some example embodiments of the present disclosure. The source 300 of the PUSCH includes the inband resource and the extension resource. As shown in FIG. 3, the source 300 of the PUSCH includes inband PRBs and extended PRBs. The extended PRBs may include two parts, where the first part may carry data copied from the end of the data in the inband PRBs, and the second part may carry data copied from the front of the data in the inband PRBs.

In some embodiments, for the PUSCH transmission, the TBS may be determined based on the number of PRBs inband, and the demodulation reference signal (DMRS) may be mapped on PRBs of both inband and extension resources. In addition, the number of PRBs in the total allocation (i.e., a sum of the number of inband PRBs and the number of extended PRBs) may be used to determine the PUSCH transmission power.

FIG. 4 illustrates a schematic diagram 400 of a relation between the resource for the PUSCH and the configured uplink subband in accordance with some example embodiments of the present disclosure. A UE may be configured with uplink subband and downlink subband. For example, the configured uplink subband 410 and the configured downlink sunband 420 are shown in FIG. 4.

It is assumed that the PUSCH is extended, however at least part of the extension resource 432/434 may be located outside the configured uplink suband 410. In case the inband resource 430 is located within the configured uplink suband 410, the UE may determine that the resource for the PUSCH includes the inband resource 430 but does not include the extension resource 4332 or 434. In other words, the PUSCH is valid and the PUSCH may be transmitted on the inband resource.

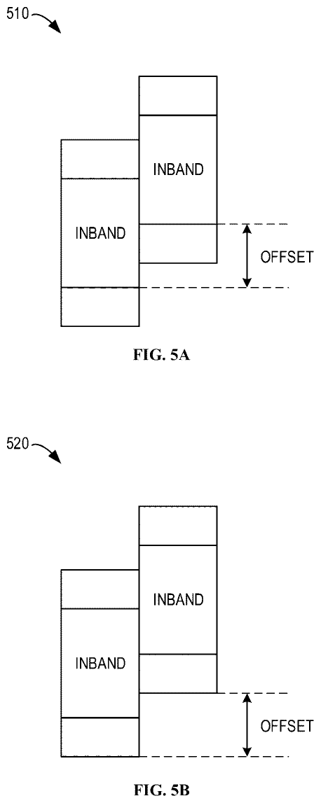

FIGS. 5A-5B illustrate schematic diagrams 510 and 520 of frequency hopping offset respectively in accordance with some example embodiments of the present disclosure. In some examples, a frequency hopping (FH) may be indicated for the PUSCH, in this case, a hopping offset (or offset) may be used to indicate a frequency offset between two adjacent hops.

As show in FIG. 5A, the hopping offset may indicate a frequency domain interval between two starting PRBs of inband resources of two hops. As shown in FIG. 5B, the hopping offset may indicate a frequency domain interval between two starting PRBs of all resources (including the inband resource and the extension resource) of two hops.

As mentioned above, a UCI may be multiplexed in the PUSCH transmission in some cases, for example, the UCI may include one or more of: a hybrid automatic repeat request—acknowledgement (HARQ-ACK), a channel state indictor (CSI), or CG-UCI. If a UE transmits a PUSCH over multiple slots and the UE would transmit a PUCCH with HARQ-ACK and/or CSI information over a single slot that overlaps with the PUSCH transmission in one or more slots of the multiple slots, and the PUSCH transmission in the one or more slots fulfills some specific conditions for multiplexing the HARQ-ACK and/or CSI information, the UE multiplexes the HARQ-ACK and/or CSI information in the PUSCH transmission in the one or more slots.

In some examples, for UCI on PUSCH, the procedure includes: (1) UCI bit sequence generation; (2) Code block segmentation and CRC attachment; (3) Channel coding of UCI; (4) Rate matching; (5) Code block concatenation; and (6) Multiplexing of coded UCI bits to PUSCH.

For example, the procedure of UCI bit sequence generation is to determine the information bits of the UCI, including HARQ-ACK, CSI part 1 and part 2, and CG-UCI. The output of this procedure may be represented as a₀, a₁, a₂, a₃, . . . , a_{A-1}, where A is the payload size. For example, in the procedure of channel coding of UCI, the UCI could be encoded by polar or channel coding of small block lengths.

For example, in the procedure of rate matching, the UE calculates the number of modulate symbols based on the scheduled PUSCH resource, configured

$${β}_{offset}^{PUSCH} ,$$

and other parameters.

For example, in the procedure of multiplexing of coded UCI bits to PUSCH, the UCI is mapping in the symbol except the DMRS, and UCI should not be mapped in the RE for phase tracking reference signal (PT-RS). For example, the HARQ-ACK is mapped from the symbol not carrying DMRS after the first DMRS symbol, and the CSI is mapped from the first symbol does not carrying DMRS.

According to the discussion above, the number of coded modulation symbols may be determined based on the scheduled PUSCH resource, and how the UCI is mapped is also related with the scheduled PUSCH resource. For example, the scheduled PUSCH resource may be represented as scheduled bandwidth of the PUSCH transmission,

$${M}_{sc}^{PUSCH} ,$$

expressed as a number of subcarriers. However, in case the PUSCH is extended, how to determine the scheduled bandwidth of the PUSCH transmission and how to map the UCI may need to be further studied.

Reference is further made to FIG. 6, which illustrates an example of a process flow 600 in accordance with some example embodiments of the present disclosure. For the purpose of discussion, the process flow 600 will be described with reference to the NE 201 and the UE 202. The process flow 600 may be applied to the wireless communications system 100 with reference to FIG. 1, for example, the NE 201 may be a network entity 102 and the UE 202 may be a UE 104. It would be appreciated that the process flow 600 may be applied to other communication scenarios, which will not be described in detail.

The UE 202 determines a UCI to be transmitted, at 610. In addition, the UE 202 may determine whether to transmit the UCI on the PUSCH or not. In some implementations, it is assumed that the PUSCH is extended, for example, an indication from the NE 201 may indicate that the PUSCH should be extended. Detailed description of the indication may refer to those discussed with reference to FIG. 2 above.

In some example embodiments, the UE 202 may determine not to multiplex the UCI with the PUSCH. In some examples, the UE 202 may determine to transmit the UCI on a PUCCH and drop the PUSCH. In some other examples, the UE 202 may determine to transmit one of the UCI or the PUSCH and drop the other of the UCI or the PUSCH based on a priority. For example, if the UCI has a higher priority than the PUSCH, the UE 202 may transmit the UCI on a PUCCH and drop the PUSCH. For another example, if the UCI has a lower priority than the PUSCH, the UE 202 may transmit the PUCH and drop the UCI. For another example, if the UCI has a same priority with the PUSCH, the UE 202 may transmit the UCI on a PUCCH and drop the PUSCH.

In some other example embodiments, as shown at 620 in FIG. 2, the UE 202 may determine to multiplex the UCI with the PUSCH. In addition, the UE 202 transmits, at 630, the UCI multiplexed with the PUSCH.

In some implementations, based on a determination that the UCI would be multiplexed with the PUSCH, the UE 202 may determine that the resource for the PUSCH includes the inband resource and excludes the extension resource. In other words, the PUSCH is not extended, and the UCI is multiplexed with the PUSCH using the inband resource.

In some other implementations, the UCI may be multiplexed with the PUSCH using the resource for the PUSCH which includes the inband resource and the extension resource. In some embodiments, the UCI may be not extended, for example, the number of UCI bits equals to the number of bits after the procedure of “(1) UCI bit sequence generation”. In some other embodiments, the UCI may be extended, for example, the number of UCI bits equals to a sum of the number of bits after the procedure of “(1) UCI bit sequence generation” and extension bits. In other words, the UCI or the extended UCI may be multiplexed with the PUSCH using the resource for the PUSCH which includes the inband resource and the extension resource.

In some examples, a number of the extension bits of the UCI (or the extended UCI) may be determined based on an extension factor or an extension RB number. For example, the extension factor and/or the extension RB number may be indicated by the information that described with reference to FIG. 2, and thus will not be repeated herein. For example, the number of the extension bits of the UCI may be represented as MO, which equals to [γ×M] or [γ×M], where γ represents the extension factor, and M represents the number of UCI bits, i.e., the number of bits after the procedure of “(1) UCI bit sequence generation”.

In some examples, the extension bits may be determined based on one or more bits in the UCI. For example, the UCI bits after the procedure of “(1) UCI bit sequence generation” may be referred to as initial UCI bits or initial UCI sequence, and the extension bits may be circulating one or more bits in the initial UCI bits. For example, the first MO bits in the initial UCI bits may be determined as the extension bits.

In some example embodiments, a number of coded modulation symbols of the UCI or the extended UCI may be further determined.

In some embodiments, the number of coded modulation symbols of the UCI or the extended UCI may be determined based on a size of the inband resource. In some examples, the size of the inband resource may be expressed as a number of RBs or a number of subcarriers. For example, if the UCI includes HARQ-ACK, the number of coded modulation symbols of the UCI or the extended UCI may be represented as Q′_{ACK}. If the UCI includes CSI part 1, the number of coded modulation symbols of the UCI or the extended UCI may be represented as Q′_{CSI-1}. If the UCI includes CSI part 2, the number of coded modulation symbols of the UCI or the extended UCI may be represented as Q′_{CSI-2}.

In some examples, the number of coded modulation symbols of the UCI or the extended UCI may be determined at least based on the number of resource elements that can be used for transmission of UCI in OFDM I:

$${M}_{sc}^{UCI} ( l ) , where {M}_{sc}^{UCI} ( l ) = {M}_{sc}^{PUSCH} - {M}_{sc}^{PT - RS} ( l ) . {M}_{sc}^{PUSCH}$$

represents the scheduled bandwidth of the inband resource, expressed as a number of subcarriers of the inband resource.

$${M}_{sc}^{PT - RS} ( l )$$

represents the number of subcarriers in OFDM symbol l that carries PTRS, in the PUSCH transmission.

As an example that the UCI includes HARQ-ACK, the number of coded modulation symbols of the UCI or the extended UCI may be determined by the following formula:

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \}$$

where,
O_{ACK} is the number of HARQ-ACK bits;
if O_{ACK}≥360 L_{ACK}=11; otherwise L_{ACK} is the number of CRC bits for HARQ-ACK determined according to Clause 6.3.1.2.1;

$${β}_{offset}^{PUSCH} = {β}_{offset}^{HARQ - ACK} ;$$

C_{UL-SCH} is the number of code blocks for UL-SCH of the PUSCH transmission;
if the DCI format scheduling the PUSCH transmission includes a CBGTI field indicating that the UE shall not transmit the r-th code block, Kᵣ=0; otherwise, Kᵣ is the r-th code block size for UL-SCH of the PUSCH transmission;

$${M}_{sc}^{UCI} ( l )$$

is the number of resource elements that can be used for transmission of UCI in OFDM symbol, for

$$l = 0 , 1 , 2 , … , {N}_{symb , all}^{PUSCH} - 1 ,$$

in the PUSCH transmission and

$${N}_{symb , all}^{PUSCH}$$

is the total number of OFDM symbols of the PUSCH, including all OFDM symbols used for DMRS;
for any OFDM symbol that carries DMRS of the PUSCH,

$${M}_{sc}^{UCI} ( l ) = 0 ;$$

for any OFDM symbol that does not carry DMRS of the PUSCH,

$${M}_{sc}^{UCI} ( l ) = {M}_{sc}^{PUSCH} - {M}_{sc}^{PT - RS} ( l ) ;$$

α is configured by higher layer parameter scaling;
l₀ is the symbol index of the first OFDM symbol that does not carry DMRS of the PUSCH, after the first DMRS symbol(s), in the PUSCH transmission.

In some other embodiments, the number of coded modulation symbols of the UCI or the extended UCI may be determined based on a size of the inband resource and further based on the extension factor or the extension RB number. In some examples, an initial number of coded modulation symbols of the UCI or the extended UCI may be determined based on a size of the inband resource, and the number of coded modulation symbols of the UCI or the extended UCI may be determined by multiplying the initial number by a sum of the extension factor and 1. For example, the number of coded modulation symbols of the UCI or the extended UCI may be expressed as Q′_{ACK}×(1+γ). For example, the number of coded modulation symbols of the UCI or the extended UCI may be expressed as

$${Q}_{ACK}^{′} + {N}_{SC}^{EX} , where {N}_{SC}^{EX}$$

represents a number of subcarriers in the extension resource.

In some other embodiments, the number of coded modulation symbols of the UCI or the extended UCI may be determined based on a size of resource of the PUSCH including the inband resource and the extension resource. In some examples, the size of the resource for the PUSCH (including the inband resource and the extension resource) may be expressed as a number of RBs or a number of subcarriers. In some examples, the number of coded modulation symbols of the UCI or the extended UCI may be determined at least based on the number of resource elements that can be used for transmission of UCI in OFDM l:

$${M}_{sc}^{UCI} ( l ) , where {M}_{sc}^{UCI} ( l ) = {M}_{sc}^{PUSCH} - {M}_{sc}^{PT - RS} ( l ) . {M}_{sc}^{PUSCH}$$

represents the scheduled bandwidth of the PUSCH transmission, expressed as a number of subcarriers of the resource for the PUSCH.

$${M}_{sc}^{PT - RS} ( l )$$

represents the number of subcarriers in OFDM symbol l that carries PTRS, in the PUSCH transmission.

In some example embodiments, the UCI or the extended UCI may be mapped to the inband resource of to the resource for the PUSCH (including the inband resource and the extension resource). In some examples, the UE 202 may map coded modulation symbols of the UCI or the extended UCI from a lowest subcarrier index of the inband resource. In some examples, the UE 202 may map coded modulation symbols of the UCI or the extended UCI from a lowest subcarrier index of the resource for the PUSCH.

Accordingly, the UE 202 may transmit the UCI or the extended UCI multiplexed on the PUSCH using the resource for the PUSCH.

According to the discussion with reference to FIG. 6, a mechanism of multiplexing UCI in the PUSCH transmission is provided. In case the resource for the PUSCH includes the inband resource and the extension resource, the UE 202 may determine whether the UCI is extended, the UE 202 may be aware to how to determine the UCI modulation symbol and how to map to the resource for the PUSCH, therefore, the transmission of the UCI may be guaranteed.

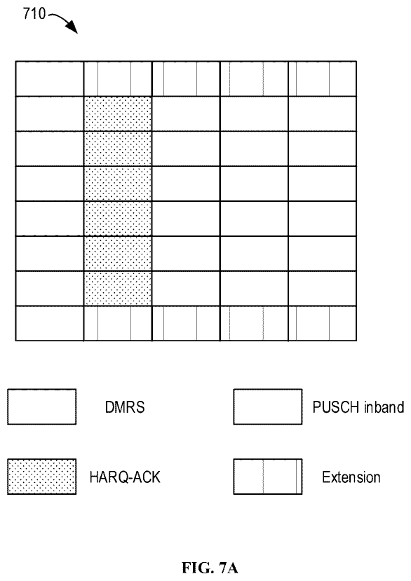

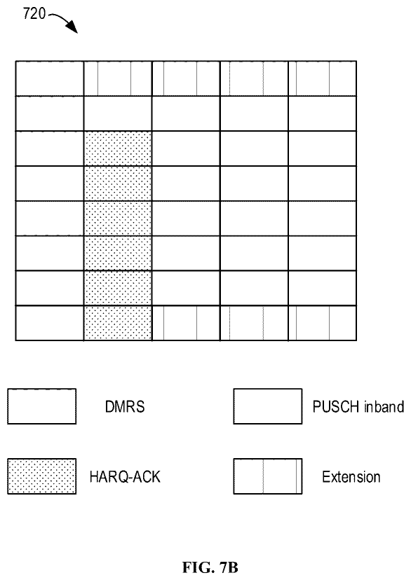

FIG. 7A-7B illustrate examples 710 and 720 of UCI mapping respectively in accordance with some example embodiments of the present disclosure. As shown in FIGS. 7A-7B, the HARQ-ACK may be mapped in the symbols except the DMRS. For example, the HARQ-ACK may be mapped in the symbols after the first DMRS symbol.

As shown in FIG. 7A, the HARQ-ACK is mapped from the lowest subcarrier index of the resource for the PUSCH including the inband resource and the extension resource. As shown in FIG. 7B, the HARQ-ACK is mapped from the lowest subcarrier index of the inband resource.

It is to be understood that the examples shown in FIGS. 7A-7B are only for illustrative without any limitation. For example, the DMRS is mapped to the first symbol; however, it may be mapped to one or more other symbols. For example, the number of coded modulation symbols of HARQ-ACK is 6; however, there may be more symbols or less symbols in other cases.

According to some embodiments discussed with reference to FIGS. 2-7B, a PUSCH indication mechanism is provided. The UE may determine a resource for the PUSCH based on information from a NE, where the information indicates an extension resource of the PUSCH. As such, the UE may transmit the PUSCH using the resource for the PUSCH, and the uplink transmission may be guaranteed. In addition, a mechanism of UCI transmission is provided. The UE may determine whether to extend the UCI which is to be multiplexed with the PUSCH. The UE may further determine a number of coded modulation symbols of the UCI and map the UCI to the resource for the PUSCH. As such, the transmission of the UCI may be guaranteed.

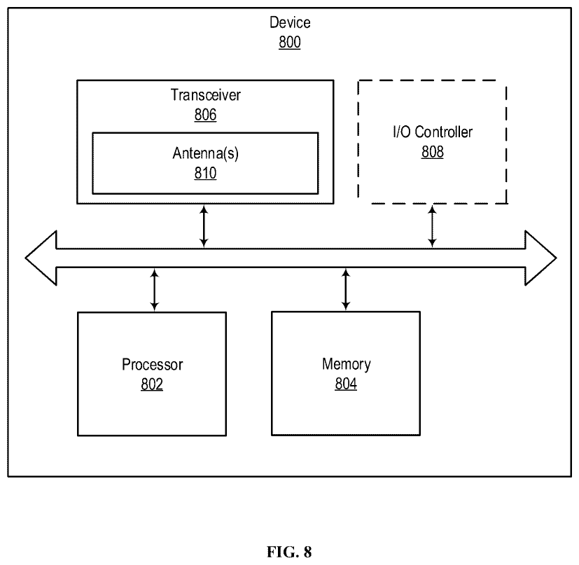

FIG. 8 illustrates an example of a device 800 that is suitable for implementing embodiments of the present disclosure. The device 800 may be an example of a network entity 102 or a UE 104 as described herein. The device 800 may support wireless communication with one or more network entities 102, UEs 104, or any combination thereof. The device 800 may include components for bi-directional communications including components for transmitting and receiving communications, such as a processor 802, a memory 804, a transceiver 806, and, optionally, an I/O controller 808. These components may be in electronic communication or otherwise coupled (e.g., operatively, communicatively, functionally, electronically, electrically) via one or more interfaces (e.g., buses).

The processor 802, the memory 804, the transceiver 806, or various combinations thereof or various components thereof may be examples of means for performing various aspects of the present disclosure as described herein. For example, the processor 802, the memory 804, the transceiver 806, or various combinations or components thereof may support a method for performing one or more of the operations described herein.

In some implementations, the processor 802, the memory 804, the transceiver 806, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 802 and the memory 804 coupled with the processor 802 may be configured to perform one or more of the functions described herein (e.g., executing, by the processor 802, instructions stored in the memory 804).

For example, the processor 802 may support wireless communication at the device 800 in accordance with examples as disclosed herein. The processor 802 may be configured to operable to support a means for receiving information from the NE, where the information is carried in a high layer message or a DCI, and where the information indicates an extension resource of a PUSCH; and means for determining a resource for the PUSCH based on the information. The processor 802 may be configured to operable to support a means for transmitting information to the UE, where the information is carried in a high layer message or a DCI, and where the information indicates an extension resource of a PUSCH; and means for receiving the PUSCH based on the information.

The processor 802 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 802 may be configured to operate a memory array using a memory controller. In some other implementations, a memory controller may be integrated into the processor 802. The processor 802 may be configured to execute computer-readable instructions stored in a memory (e.g., the memory 804) to cause the device 800 to perform various functions of the present disclosure.

The memory 804 may include random access memory (RAM) and read-only memory (ROM). The memory 804 may store computer-readable, computer-executable code including instructions that, when executed by the processor 802 cause the device 800 to perform various functions described herein. The code may be stored in a non-transitory computer-readable medium such as system memory or another type of memory. In some implementations, the code may not be directly executable by the processor 802 but may cause a computer (e.g., when compiled and executed) to perform functions described herein. In some implementations, the memory 804 may include, among other things, a basic I/O system (BIOS) which may control basic hardware or software operation such as the interaction with peripheral components or devices.

The I/O controller 808 may manage input and output signals for the device 800. The I/O controller 808 may also manage peripherals not integrated into the device M02. In some implementations, the I/O controller 808 may represent a physical connection or port to an external peripheral. In some implementations, the I/O controller 808 may utilize an operating system such as iOS®, ANDROID®, MS-WINDOWS®, OS/2®, UNIX®, LINUX®, or another known operating system. In some implementations, the I/O controller 808 may be implemented as part of a processor, such as the processor 806. In some implementations, a user may interact with the device 800 via the I/O controller 808 or via hardware components controlled by the I/O controller 808.

In some implementations, the device 800 may include a single antenna 810.

However, in some other implementations, the device 800 may have more than one antenna 810 (i.e., multiple antennas), including multiple antenna panels or antenna arrays, which may be capable of concurrently transmitting or receiving multiple wireless transmissions. The transceiver 806 may communicate bi-directionally, via the one or more antennas 810, wired, or wireless links as described herein. For example, the transceiver 806 may represent a wireless transceiver and may communicate bi-directionally with another wireless transceiver. The transceiver 806 may also include a modem to modulate the packets, to provide the modulated packets to one or more antennas 810 for transmission, and to demodulate packets received from the one or more antennas 810. The transceiver 806 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 810 for transmitting the amplified signal into the air or wireless medium.

A receive chain may be configured to receive signals (e.g., control information, data, packets) over a wireless medium. For example, the receive chain may include one or more antennas 810 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

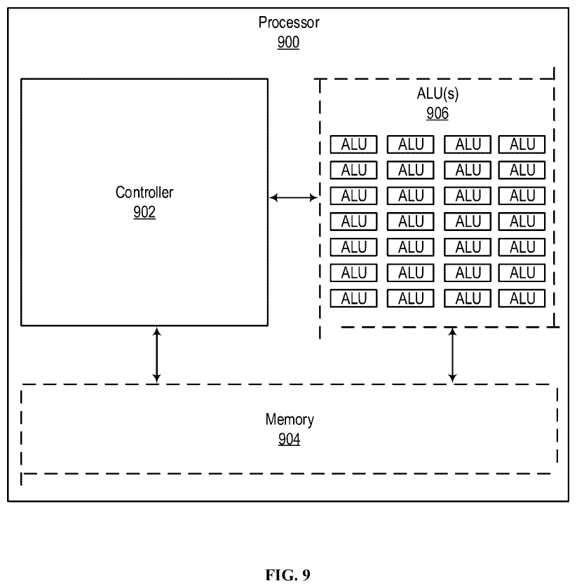

FIG. 9 illustrates an example of a processor 900 that is suitable for implementing some embodiments of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, such as L1/L2/L3 cache. Additionally, or alternatively, the processor 900 may optionally include one or more arithmetic-logic units (ALUs) 900. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementation, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 900 may be configured to support various operations in accordance with examples as described herein. In some implementation, the one or more ALUs 900 may reside within or on a processor chipset (e.g., the processor 900). In some other implementations, the one or more ALUs 900 may reside external to the processor chipset (e.g., the processor 900). One or more ALUs 900 may perform one or more computations such as addition, subtraction, multiplication, and division on data. For example, one or more ALUs 900 may receive input operands and an operation code, which determines an operation to be executed. One or more ALUs 900 be configured with a variety of logical and arithmetic circuits, including adders, subtractors, shifters, and logic gates, to process and manipulate the data according to the operation. Additionally, or alternatively, the one or more ALUs 900 may support logical operations such as AND, OR, exclusive-OR (XOR), not-OR (NOR), and not-AND (NAND), enabling the one or more ALUs 900 to handle conditional operations, comparisons, and bitwise operations.

The processor 900 may support wireless communication in accordance with examples as disclosed herein. The processor 900 may be configured to or operable to support a means for operations described in some embodiments of the present disclosure.

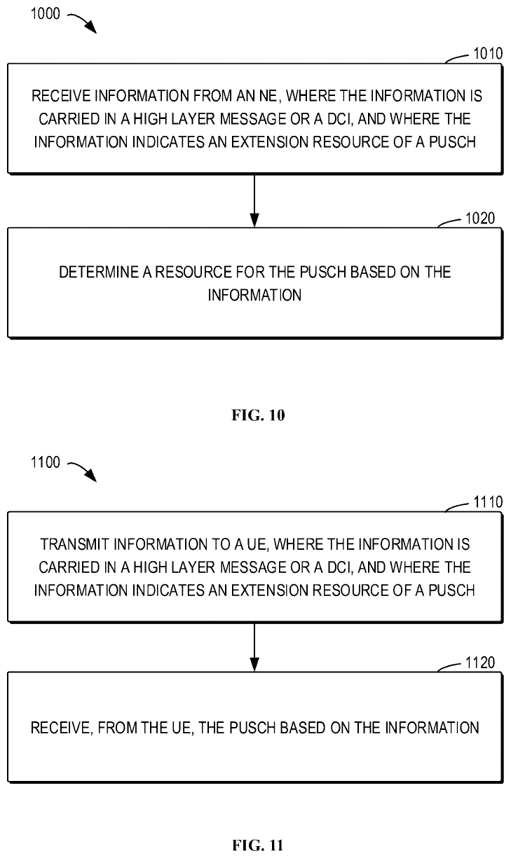

FIG. 10 illustrates a flowchart of a method 1000 performed by a UE in accordance with aspects of the present disclosure. The operations of the method 1000 may be implemented by a device or its components as described herein. For example, the operations of the method 1000 may be performed by a UE 104 in FIG. 1. In some implementations, the device may execute a set of instructions to control the function elements of the device to perform the described functions. Additionally, or alternatively, the device may perform aspects of the described functions using special-purpose hardware.

At 1010, the method may include receiving information from an NE, where the information is carried in a high layer message or a DCI, and the information indicates an extension resource of a PUSCH. The operations of 1010 may be performed in accordance with examples as described herein. In some implementations, aspects of the operations of 1010 may be performed by a UE 104 as described with reference to FIG. 1.

At 1020, the method may include determining a resource for the PUSCH based on the information. The operations of 1020 may be performed in accordance with examples as described herein. In some implementations, aspects of the operations of 1020 may be performed by a UE 104 as described with reference to FIG. 1.

In some implementations, the UE may receive, from the NE, an indication indicating whether the PUSCH is extended.

In some implementations, the indication comprises at least one bit in the DCI. In some implementations, bit fields carrying the at least one bit for different DCI formats are configured separately. In some examples, whether the bit fields of the DCI carrying the at least one bit are configured per DCI format.

In some implementations, the indication is carried in an RRC message based at least in part on the PUSCH being scheduled via a fallback DCI format or the PUSCH being a CG PUSCH. In some implementations, the indication is carried in a SIB based at least in part on the PUSCH being a random access message of a random access procedure, the random access message comprises a msg3 PUSCH.

In some implementations, the information comprises an extension factor, or an extension RB number for indicating the extension resource.

In some implementations, the information comprises an index of the extension factor among a plurality of factors, or a resource size associated with the extension factor. In some implementations, the information comprises an index of the extension RB number of a plurality of RB numbers, or a resource size associated with the extension RB number.

In some implementations, the resource size comprises a size of an inband resource of the PUSCH, or a size of the resource for the PUSCH comprising the inband resource and the extension resource.

In some implementations, the UE may receive, from the NE, a configuration comprising: the plurality of factors, the plurality of extension RB numbers, an association between at least one extension factor and at least one range of resource sizes, or an association between at least one extension RB number and at least one range of resource sizes.

In some implementations, in response to the extension resource being located outside a configured uplink subband of the UE and an inband resource being located within the configured uplink subband, the UE may determine that the resource for the PUSCH comprises the inband resource and excludes the extension resource. In some implementations, in response to both the inband resource and the extension resource being located within the configured uplink subband, the UE may determine that the resource for the PUSCH comprises the inband resource and the extension resource.

In some implementations, the UE may determine a UCI to be multiplexed with the PUSCH; and determine whether to transmit the UCI on the PUSCH.

In some implementations, the UE may determine that the resource for the PUSCH comprises an inband resource and excludes the extension resource; and transmit the UCI being multiplexed with the PUSCH on the inband resource.

In some implementations, the UE may transmit the UCI on a PUCCH by dropping the PUSCH. In some implementations, the UE may transmit one of the UCI or the PUSCH with a higher priority.

In some implementations, the UE may determine that the resource for the PUSCH comprises an inband resource and the extension resource; and transmit the UCI or an extended UCI being multiplexed with the PUSCH on the resource for the PUSCH.

In some implementations, the UE may determine the extended UCI based at least in part on the UCI, one or more bits in the UCI, and an extension resource.

In some implementations, the UE may determine a number of coded modulation symbols of the UCI or the extended UCI based at least in part on a size of the inband resource or a size of the resource for the PUSCH.

In some implementations, the UE may map coded modulation symbols of the UCI or the extended UCI from a lowest subcarrier index of the inband resource or from a lowest subcarrier index of the resource for the PUSCH.

FIG. 11 illustrates a flowchart of a method 1100 performed by an NE in accordance with aspects of the present disclosure. The operations of the method 1100 may be implemented by a device or its components as described herein. For example, the operations of the method 1100 may be performed by a network entity 102 as described herein. In some implementations, the device may execute a set of instructions to control the function elements of the device to perform the described functions. Additionally, or alternatively, the device may perform aspects of the described functions using special-purpose hardware.

At 1110, the method may include transmitting information to a UE, where the information is carried in a high layer message or a DCI, and where the information indicates an extension resource of a PUSCH. The operations of 1110 may be performed in accordance with examples as described herein. In some implementations, aspects of the operations of 1110 may be performed by a network entity 102 as described with reference to FIG. 1.

At 1120, the method may include receiving, from the UE, the PUSCH based on the information. The operations of 1120 may be performed in accordance with examples as described herein. In some implementations, aspects of the operations of 1120 may be performed by a network entity 102 as described with reference to FIG. 1.

In some implementations, the NE may transmit, to the UE, an indication indicating whether the PUSCH is extended.

In some implementations, the indication comprises at least one bit in the DCI. In some implementations, bit fields carrying the at least one bit for different DCI formats are configured separately.

In some implementations, the indication is carried in an RRC message based at least in part on the PUSCH being scheduled via a fallback DCI format or the PUSCH being a CG PUSCH. In some implementations, the indication is carried in a SIB based at least in part on the PUSCH being a random access message of a random access procedure, the random access message comprises a msg3 PUSCH.

In some implementations, the information comprises an extension factor, or an extension RB number for indicating the extension resource.

In some implementations, the information comprises an index of the extension factor among a plurality of factors, a resource size associated with the extension factor. In some implementations, the information comprises an index of the extension RB number of a plurality of RB numbers, a resource size associated with the extension RB number.

In some implementations, the resource size comprises a size of an inband resource of the PUSCH, or a size of the resource for the PUSCH comprising the inband resource and the extension resource.

In some implementations, the NE may transmit, to the UE, a configuration comprising: the plurality of factors, the plurality of extension RB numbers, an association between at least one extension factor and at least one range of resource sizes, or an association between at least one extension RB number and at least one range of resource sizes.

In some implementations, the NE may receive, from the UE, a UCI being multiplexed with the PUSCH on an inband resource or being transmitted on a PUCCH with the PUSCH being dropped.

In some implementations, the NE may receive, from the UE, one of a UCI or the PUSCH with a higher priority.

In some implementations, the NE may receive, from the UE, a UCI or an extended UCI being multiplexed with the PUSCH using the resource for the PUSCH comprising an inband resource and the extension resource.

In some implementations, the extended UCI is determined based at least in part on the UCI, one or more bits in the UCI, and an extension resource.

In some implementations, the NE may determine a number of coded modulation symbols of the UCI or the extended UCI based at least in part on a size of the inband resource or a size of the resource for the PUSCH.

In some implementations, the coded modulation symbols of the UCI or the extended UCI are mapped from a lowest subcarrier index of the inband resource or from a lowest subcarrier index of the resource for the PUSCH.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer.

By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive information, wherein the information is carried in a high layer message or downlink control information (DCI), and wherein the information indicates an extension resource of a physical uplink shared channel (PUSCH); and
determine a resource for the PUSCH based at least in part on the information.

2. The UE of claim 1, wherein the at least one processor is further configured to cause the UE to:
receive an indication indicating whether the PUSCH is extended.

3. The UE of claim 2, wherein the indication comprises at least one bit in the DCI.

4. The UE of claim 3, wherein bit fields carrying the at least one bit for different DCI formats are configured separately.

5. The UE of claim 1, wherein the information comprises an extension factor, or an extension resource block (RB) number for indicating the extension resource.

6. The UE of claim 5, wherein:
the information comprises an index of the extension factor among a plurality of extension factors, or a resource size associated with the extension factor; or
the information comprises an index of the extension RB number of a plurality of extension RB numbers, or a resource size associated with the extension RB number.

7. The UE of claim 6, wherein the resource size comprises a size of an inband resource of the PUSCH, or a size of the resource for the PUSCH comprising the inband resource and the extension resource.

8. The UE of claim 6, wherein the at least one processor is further configured to cause the UE to:
receive a configuration comprising:
the plurality of factors,
the plurality of extension RB numbers,
an association between at least one extension factor and at least one range of resource sizes, or
an association between at least one extension RB number and at least one range of resource sizes.

9. The UE of claim 1, wherein the at least one processor is further configured to cause the UE to:
determine uplink control information (UCI) to be multiplexed with the PUSCH; and
determine whether to transmit the UCI on the PUSCH.

10. The UE of claim 9, wherein the at least one processor is further configured to cause the UE to:
determine that the resource for the PUSCH comprises an inband resource and the extension resource; and
transmit the UCI or an extended UCI on the resource for the PUSCH.

11. The UE of claim 10, wherein the at least one processor is further configured to cause the UE to:
determine the extended UCI based at least in part on the UCI, one or more bits in the UCI, and the extension resource.

12. The UE of claim 10, wherein the at least one processor is configured to cause the UE to:
determine a number of coded modulation symbols of the UCI or the extended UCI based at least in part on a size of the inband resource or a size of the resource for the PUSCH.

13. The UE of claim 10, wherein the at least one processor is configured to cause the UE to:
map coded modulation symbols of the UCI or the extended UCI from a lowest subcarrier index of the inband resource or from a lowest subcarrier index of the resource for the PUSCH.

14. A network equipment (NE) for wireless communication, comprising:
at least one memory; and
at least one processor coupled with the at least one memory and configured to cause the NE to:
transmit information, wherein the information is carried in a high layer message or downlink control information (DCI), and wherein the information indicates an extension resource of a physical uplink shared channel (PUSCH); and
receive the PUSCH based at least in part on the information.

15. A method performed by a user equipment (UE), comprising:
receiving information, wherein the information is carried in a high layer message or downlink control information (DCI), and wherein the information indicates an extension resource of a physical uplink shared channel (PUSCH); and
determining a resource for the PUSCH based at least in part on the information.

16. The method of claim 15, further comprising:
receiving an indication indicating whether the PUSCH is extended.

17. The method of claim 15, wherein the information comprises an extension factor, or an extension resource block (RB) number for indicating the extension resource.

18. The method of claim 15, further comprising:
determining uplink control information (UCI) to be multiplexed with the PUSCH; and
determining whether to transmit the UCI on the PUSCH.

19. The method of claim 18, further comprising:
determine that the resource for the PUSCH comprises an inband resource and the extension resource; and
transmit the UCI or an extended UCI on the resource for the PUSCH.

20. A method performed by a network equipment (NE), the method comprising:
transmitting information, wherein the information is carried in a high layer message or downlink control information (DCI), and wherein the information indicates an extension resource of a physical uplink shared channel (PUSCH); and
receiving the PUSCH based at least in part on the information.
